(19) United States
(12) Patent Application Publication
(10) Pub. No.: US 2024/0042659 A1
(43) Pub. Date: Feb. 8, 2024

(54) MOLDING TOOL, MOLDING APPARATUS, AND METHOD OF MOLDING OBJECTS

(71) Applicant: DAH LIH PUH CO., LTD., Taichung City (TW)

(72) Inventor: JUI-FEN SHIAO, Taichung City (TW)

(73) Assignee: DAH LIH PUH CO., LTD., Taichung City (TW)

(21) Appl. No.: 17/991,575

(22) Filed: Nov. 21, 2022

(30) Foreign Application Priority Data
Aug. 5, 2022 (TW) 111129596

(51) Int. Cl. B29C 43/36; B29C 43/02; B29C 43/34

(52) U.S. Cl. CPC B29C 43/36; B29C 43/021; B29C 43/34; B29C 2043/3416; B29C 2043/3602; B29C 2043/3665

(57) ABSTRACT

A molding tool includes a top die, a bottom die, and several middle dies. Each middle die has a molding hole. The top die or the bottom die has a core, and the other one has a partial cavity. The partial cavity and each molding hole jointly form a cavity matching the core. The top die is opposite to the bottom die. The top die and/or the bottom die are/is driven to move towards or away from each other. Each middle die is moved to a position between the top die and the bottom die, allowing each middle die to be clamped with the top die and the bottom die. Upon using, a raw material is disposed on each middle die before the middle dies being sequentially moved to the position, making the top die, the bottom die, and the middle die clamp to process the raw material into a product.

### BACKGROUND OF THE INVENTION

### Technical Field

The present invention relates generally to a molding tool constituting of three pieces, and more particularly to a molding tool, a molding apparatus, and a method of molding objects.

### Description of Related Art

A conventional molding tool includes a male mold and a female mold. Upon using, the male mold and the female mold are disposed on a molding apparatus in a way of being spaced along a top-bottom direction. A raw material is disposed on the female mold during processing, then the molding apparatus drives the male mold and the female mold to move towards one another, making the male mold and the female mold clamp to process the raw material into a product.

The conventional molding tool could process the raw material via the male mold and the female mold. However, as the raw material is required to be manually disposed in a position between the male mold and the female mold during processing, in which the position is within a boundary of the male mold and the female mold moving towards one another to clamp, the industrial safety risk that workers might be clamped and injured by the conventional molding tool during disposing the raw material manually is concerned. Besides, as a space of disposing the raw material is limited, a problem that the produced product is defective would be easily caused as a position of positioning the raw material is inaccurate Moreover, as the raw material placement is required each time before the male mold and the female mold are clamped, the process cannot continue due to waiting for placing the raw material, thereby the productivity cannot be increased.

### BRIEF SUMMARY OF THE INVENTION

In view of the above, the primary objective of the present invention is to divide a molding tool into three pieces including a top die, a bottom die, and at least two middle dies, thereby a molding hole of each of the middle dies could match with a partial cavity of the top die or the bottom die to constitute a cavity, so that a user could dispose a raw material on each of the middle dies in advance, and process the raw material by sequentially moving the middle dies to a position between the top die and the bottom die.

The present invention provides a molding tool including a top die, a bottom die, and at least two middle dies, wherein each of the middle dies has a molding hole that is penetrating therethrough. Either the top die or the bottom die has a core adapted to mold objects, and the other of the top die and the bottom die has a partial cavity. The partial cavity and the molding hole of each of the middle dies jointly form a cavity matching with the core. The top die is opposite to the bottom die. One or both of the top die and the bottom die is/are driven to move towards or away from each other. The middle dies are respectively moved to a position between the top die and the bottom die, allowing one of the middle dies to be clamped with the top die and the bottom die.

The present invention further provides a molding apparatus including a first driving device, a second driving device, and the aforementioned molding tool, wherein the top die and the bottom die are disposed on the first driving device to face each other. The first driving device drives one or both of the top die and the bottom die to move towards or away from each other along a straight-line direction. The middle dies are arranged in a row on the second driving device, and are respectively moved to or retracted from the position between the top die and the bottom die along a direction perpendicular to the straight-line direction.

The present invention further provides a method of molding objects including steps of: preparing the aforementioned molding tool; disposing a raw material adapted to be molded on each of the middle dies, and moving one of the middle dies to the position between the top die and the bottom die; driving one or both of the top die and the bottom die to move towards each other until the top die, the bottom die, and the middle die are clamped to mold the raw material; driving one or both of the top die and the bottom die to move away from each other until the top die and the bottom die are separated by a predetermined distance after the raw material in the molding tool is molded into a required object; withdrawing one of the middle dies located between the top die and the bottom die; and moving another one of the middle dies having the raw material to the position between the top die and the bottom die, and driving one or both of the top die and the bottom die to move towards each other until the top die, the bottom die, and the another middle die are clamped to mold the raw material of the another middle die.

The molding tool, the molding apparatus, and the method of molding objects of the present invention could be applied to processing and manufacturing including hot-press molding, cold-press molding, or die cutting. With the aforementioned design, as the molding tool is constituted of three pieces including the top die, the at least two middle dies, and the bottom die, the raw material could be disposed on each of the middle dies before the molding tool is clamped, avoiding the conventional problem of inaccurate placement of the raw material due to insufficient operating space and limited time interval between the upper mold and the lower mold clamping, thereby increasing the yield rate of processing the raw material into an object and reducing the industrial safety risk of the workers during process, and increasing the productivity of processing and manufacturing by reducing the time of disposing the raw material each time before clamping of the molding tool.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is an exploded view of the molding tool according to an embodiment of the present invention;

FIG. 2 is a schematic view showing the cavity formed by the partial cavity and the molding hole:

FIG. 3 is a schematic view showing the raw material is disposed on one of the middle dies;

FIG. 4 is a schematic view of the molding apparatus according to the embodiment of the present invention;

FIG. 5 is a perspective view of the molding apparatus according to the embodiment of the present invention;

FIG. 6 is a flowchart of the method of molding objects of the present invention; and

FIG. 7A to FIG. 7E are respectively a schematic view showing the process of the method of molding objects of the present invention.

### DETAILED DESCRIPTION OF THE INVENTION

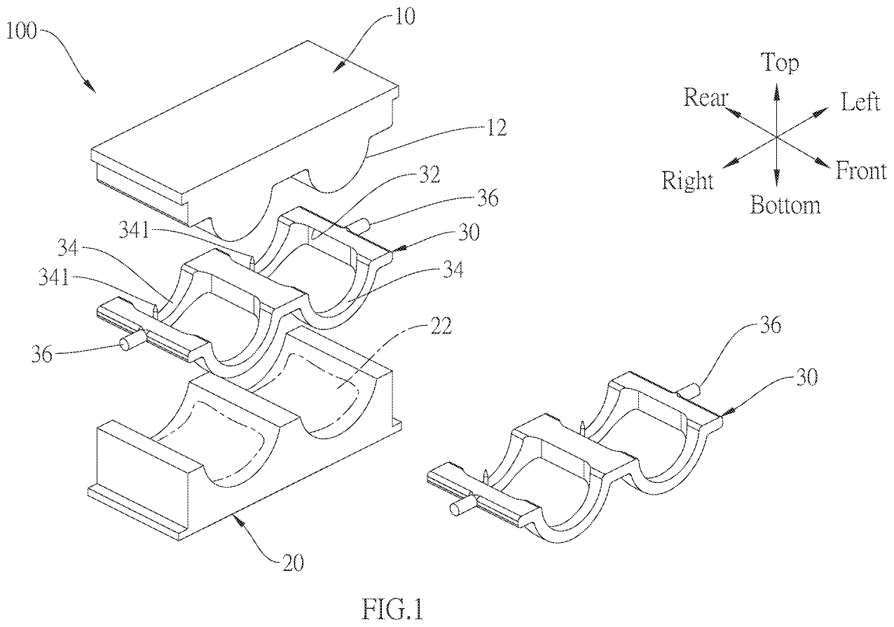

In the description below, the terms “up”, “down”, “top”, “bottom”, “front”, “rear”, “left”. “right”, and their derivatives, should be interpreted from the exploded view of the present invention in FIG. 1. It is also understood that the terminology used herein is for the purpose of describing particular embodiments only, and is not intended to limit the scope of the present invention. A molding tool 100 according to an embodiment of the present invention is illustrated in FIG. 1 to FIG. 3 and includes a top die 10, a bottom die 20, and at least two middle dies 30. Either the top die 10 or the bottom die 20 has a core 12 adapted to mold an object, and the other of the top die 10 and the bottom die 20 has a partial cavity 22. Each of the middle dies 30 has a molding hole 32 that is penetrating therethrough, wherein the molding hole 32 and the partial cavity 22 of the top die 10 or the bottom die 20 jointly form a cavity A matching with the core 12. The top die 10 and the bottom die 20 of the molding tool 100 could be driven to move towards or away from each other, and the middle dies 30 could be respectively moved to a position between the top die 10 and the bottom die 20, so that one of the middle dies 30 is clamped with the top die 10 and the bottom die 20, and the core 12 matches with the cavity A to process a raw material B disposed on each of the middle dies 30 into the object.

More specifically, in the current embodiment, two cores 12 are respectively provided in a left position and a right position of a bottom of the top die 10, and two partial cavities 22 are respectively provided in a left position and a right position of a top of the bottom die 20, and two molding holes 32 that are penetrating therethrough are respectively provided on a left side and a right side of each of the middle dies 30, wherein each of the molding holes 32 matches with one of the partial cavities 22 to jointly form one cavity A matching with one of the cores 12, so that two structures of the two cores 12 matching with the two cavities A are constituted. In other embodiments, a position in which the cores 12 and the partial cavities 22 are provided could be swapped (e.g. the two core 12 are provided in the bottom die 20 and the two partial cavities 22 are provided in the top die 10), and the number of the structure that the core 12 matches with the cavity A (including the partial cavity 22 and the molding hole 32) is not limited to two, but could be one, three, or more.

The middle dies 30 have a frame structure 34 on a periphery of each of the molding holes 32. When the top die 10 and bottom die 20 clamp one of the middle dies 30, each of the frame structures 34 is clamped between the core 12 of the top die 10 and a part of the bottom die 20 located on a periphery of the partial cavity 22. A top surface of each of the frame structures 34 has a positioning pin 341. When the raw material B is disposed on each of the frame structures 34 of the middle dies 30, each of the positioning pins 341 could position the raw material B by penetrating through the raw material B. In other embodiments, the number of the positioning pin 341 provided on the top surface of each of the frame structures 34 could be two or more to fix the raw material B on the middle dies 30 by penetrating through the raw material B. The left side and the right side of each of the middle dies 30 respectively have a lug 36 protruding out of a boundary in which each of the middle dies 30 is clamped with the top die 10 and the bottom die 20.

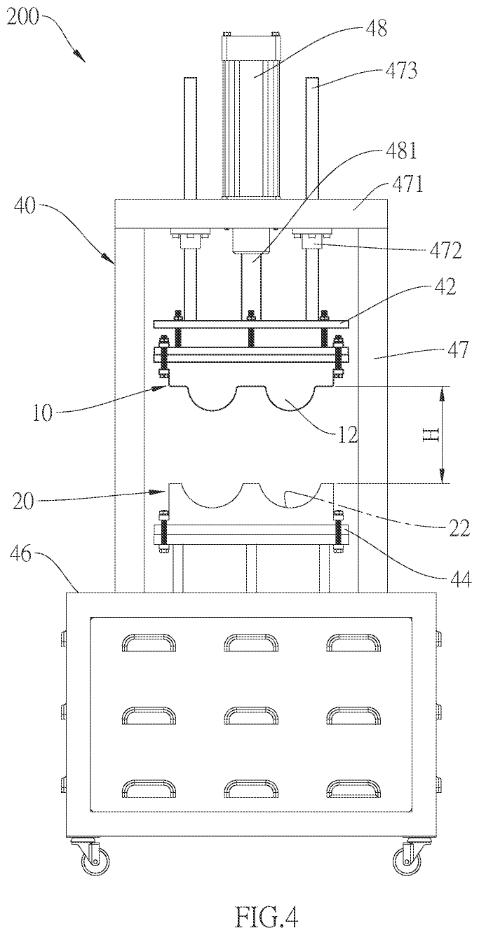

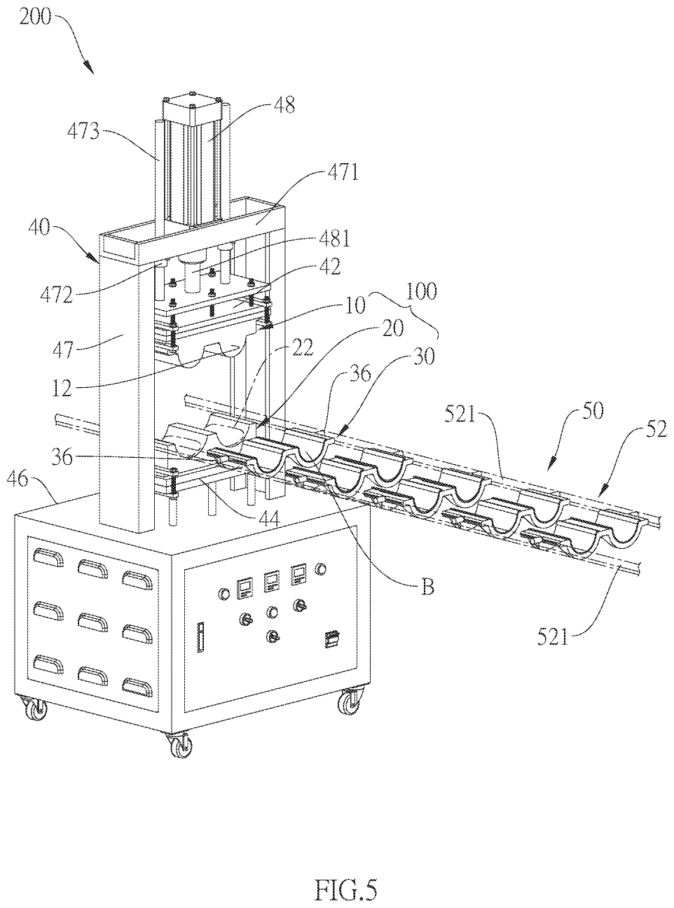

As shown in FIG. 4 and FIG. 5, the molding tool 100 is installed on a molding apparatus 200 upon using, and the molding apparatus 200 includes a first driving device 40 and a second driving device 50. The first driving device 40 has a top seat 42 and a bottom seat 44, wherein the top seat 42 and the bottom seat 44 could be driven by a linear actuator to move towards or away from each other along a straight-line direction. The top die 10 and the bottom die 20 are respectively disposed on the top seat 42 and the bottom seat 44 of the first driving device 40, making the top die 10 and the bottom die 20 face each other and be spaced by a predetermined distance H in a top-bottom direction (i.e., the straight-line direction), and move towards or away from each other along the top-bottom direction when driven by the first driving device 40.

The second driving device 50 has a conveyor 52, wherein the middle dies 30 are arranged at intervals on the conveyor 52, so that the middle dies 30 arranged in a row on the second driving device 50 could be respectively moved to or retracted from the position between the top die 10 and the bottom die 20 along a direction (i.e., a front-rear direction in the current embodiment) perpendicular to the straight-line direction in which the top die 10 and the bottom die 20 move towards or away from each other. More specifically, referring to FIG. 5, as a position of the bottom die 20 in the current embodiment is fixed, the second driving device 50 drives each of the middle dies 30 to move to a position matching with the bottom die 20 along another straight-line direction (i.e., the front-rear direction), so that each of the molding holes 32 of one of the middle dies 30 could form the cavity A with one of the partial cavities 22 of the bottom die 20. At that time, when the top die 10 is moving downwards along the top-bottom direction, the middle die 30 is located at a position clamped by the top die 10 at the top and clamped and supported by the bottom die 20.

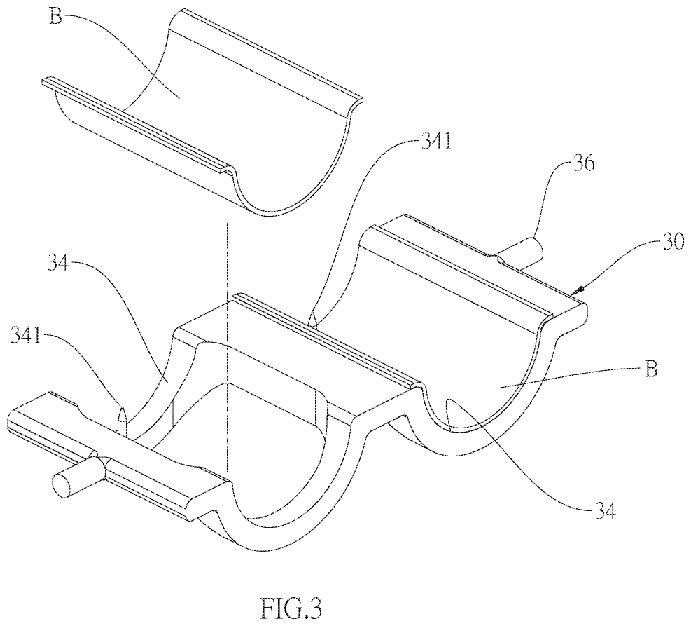

As shown in FIG. 3 to FIG. 5, the first driving device 40 of the molding apparatus 200 includes a bottom base 46, wherein the bottom seat 44 is disposed on the bottom base 46, and the bottom die 20 is detachably engaged with a top surface of the bottom seat 44. A frame 47 is disposed on the bottom base 46 and has a crossbeam 471 located directly above the bottom seat 44. A driving cylinder 48 is engaged with a middle of the crossbeam 471 and has a piston rod 481 extending downwards along the top-bottom direction. Two guiding cylinders 472 are respectively disposed on a left side and a right side of the crossbeam 471, wherein each of the two guiding cylinders 472 is penetrated by a guiding rod 473. A bottom end of the piston rod 481 and a bottom end of each of the two guiding rods 473 are respectively engaged with the top seat 42. The top die 10 is detachably engaged with a bottom surface of the top seat 42. In this way, the driving cylinder 48 could drive the top die 10 to lift or decline, making the top die 10 and the bottom die 20 move towards or away from each other.

In other embodiments, the top seat 42 and the top die 10 could be fixed on the crossbeam 471, and both the driving cylinder 48 and the two guiding rods 473 could be disposed on the bottom base 46 and adapted to connect to and drive the bottom seat 44 and the bottom die 20; alternatively, the top seat 42 and the top die 10 are remained to be driven by the driving cylinder 48 to lift or decline, and another driving cylinder 48 and another two guiding rods 473 are additionally disposed on the bottom base 46 and adapted to connect to and drive the bottom seat 44 and the bottom die 20 to lift or decline. With the aforementioned structure, one or both of the top die 10 and the bottom die 20 of the molding tool 100 could be driven to move towards or away from each other. Moreover, the driving cylinder 48 could be changed to other linear driving devices, such as an electric linear actuator, to drive one or both of the top die 10 and the bottom die 20 to move towards or away from each other.

The conveyor 52 of the second driving device 50 further includes two belts 521 arranged by an interval in a left-right direction, wherein the two belts 521 respectively pass through a left side and a right side of a position in which the top die 10 and the bottom die 20 clamp the middle dies 30. The middle dies 30 are engaged between the two belts 521. For example, in the current embodiment, the left side and the right side of each of the middle dies 30 respectively have one lug 36, and each of the middle dies 30 is detachably engaged with the two belts 521 via the two lugs 36. In this way, the conveyor 52 of the second driving device 50 could move the middle dies 30 having the raw material B to the position between the top die 10 and the bottom die 20, and the top die 10 and the bottom die 20 could be driven to clamp with one of the middle dies 30 to process the raw material B into a product, then the conveyor 52 could move another one of the middle dies 30 having a raw material B to repeat the process of processing the raw material B into a product after the top die 10 and the bottom die 20 move away from one another to the predetermined distance H.

Apart from the second driving device 50 having the conveyor 52 in the current embodiment, the second driving device 50 could be at least one robotic arm that could freely move the middle dies 30. The at least one robotic arm moves each of the middle dies 30 having the raw material B to the position between the top die 10 and the bottom die 20, then the top die 10 and the bottom die 20 clamp one of the middle dies 30 to process the raw material B. and the middle die 30 is withdrawn after the top die 10 and the bottom die 20 are retracted, and at the same time, another one of the middle dies 30 having the raw material B is moved to the position between the top die 10 and the bottom die 20 to repeat the process.

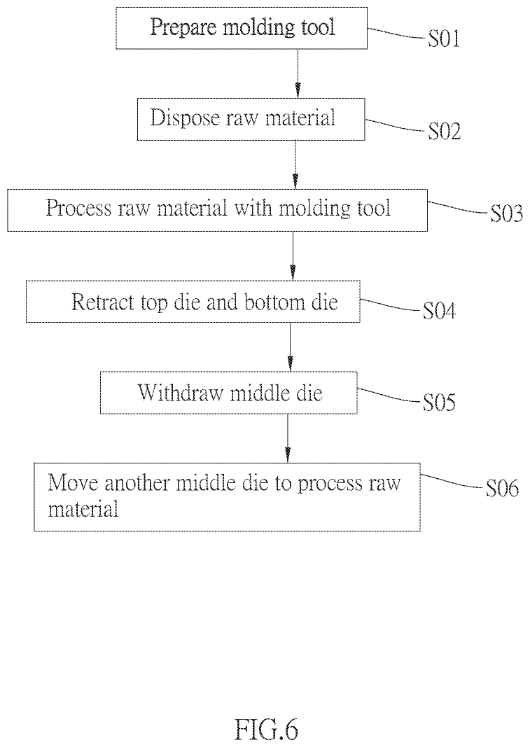

A method of molding objects is illustrated in a flowchart as shown in FIG. 6 and is taken when the molding tool 100 is installed on the molding apparatus 200. The method of molding objects includes the following steps:

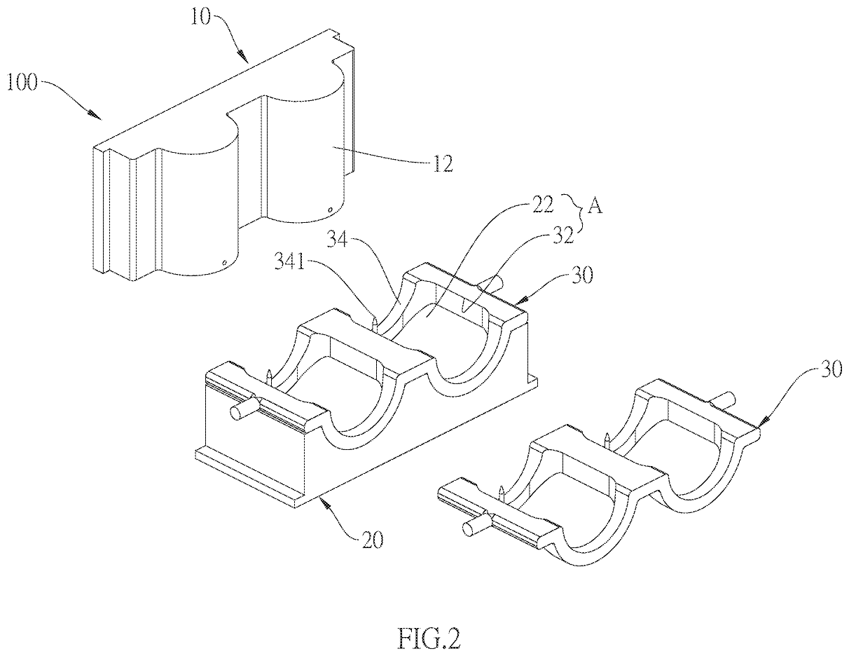

S01, prepare a molding tool 100: as shown in FIG. 1 and FIG. 2, the molding tool 100 including a top die 10, a bottom die 20, and at least two middle dies 30 is prepared; either the top die 10 or the bottom die 20 has a core 12 adapted to mold an object, and the other of the top die 10 and the bottom die 20 has a partial cavity 22; each of the middle dies 30 has a molding hole 32 that is penetrating therethrough, and the molding hole 32 and the partial cavity 22 of the top die 10 or the bottom die 20 jointly form a cavity A matching with the core 12; one or both of the top die 10 and the bottom die 20 of the molding tool 100 is driven to move towards or away from each other, and the middle dies 30 are respectively moved to a position between the top die 10 and the bottom die 20, so that one of the middle dies 30 is clamped with the top die 10 and the bottom die 20, and the core 12 matches with the cavity A to process a raw material B disposed on each of the middle dies 30 into the object:

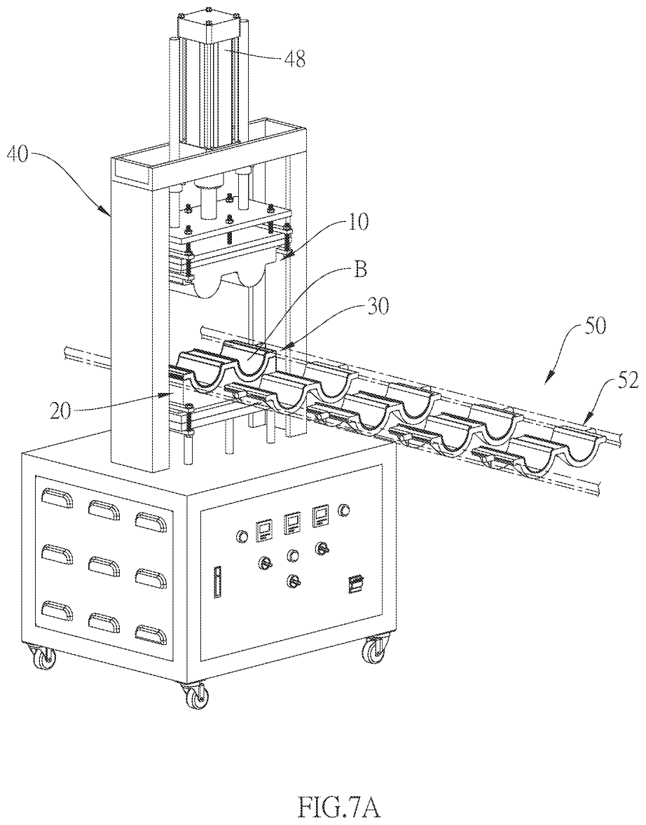

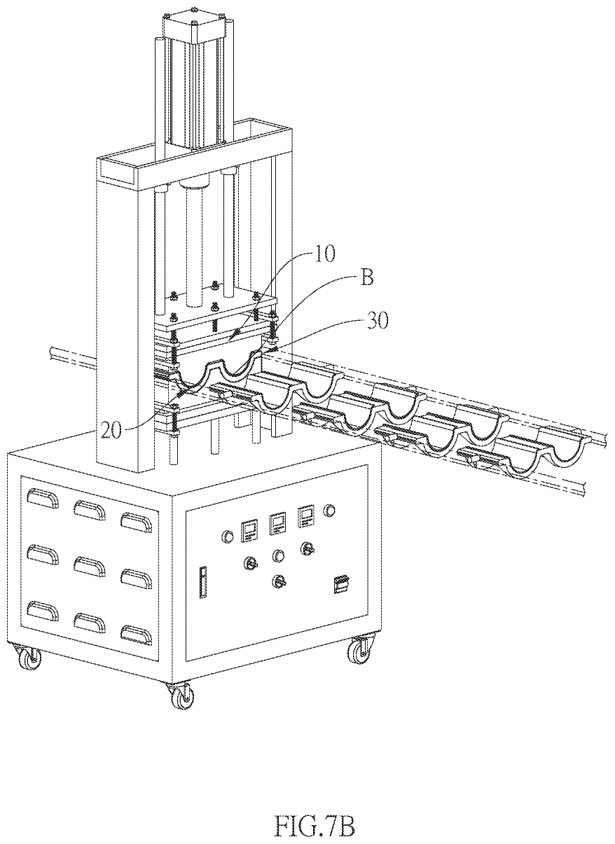

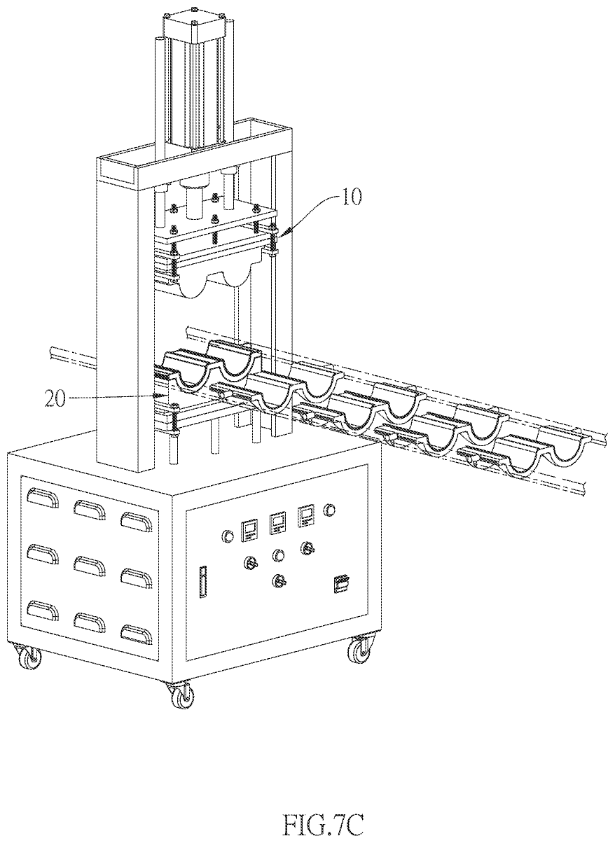

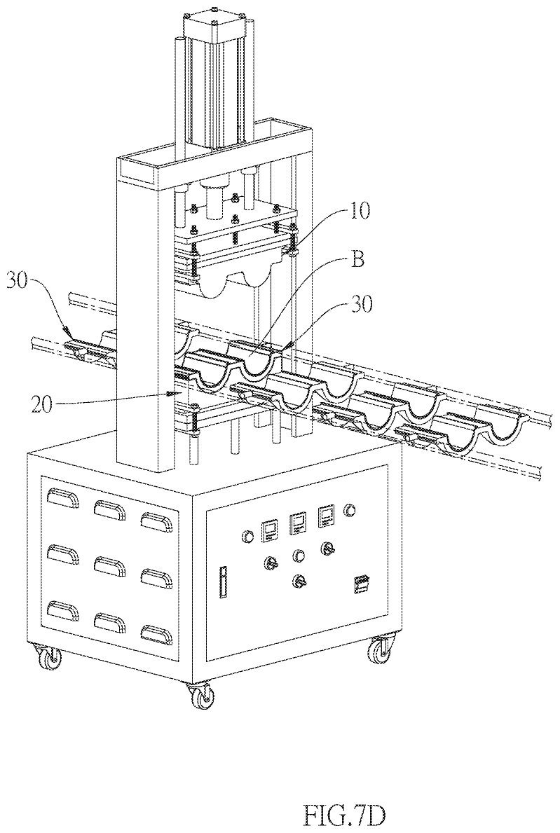

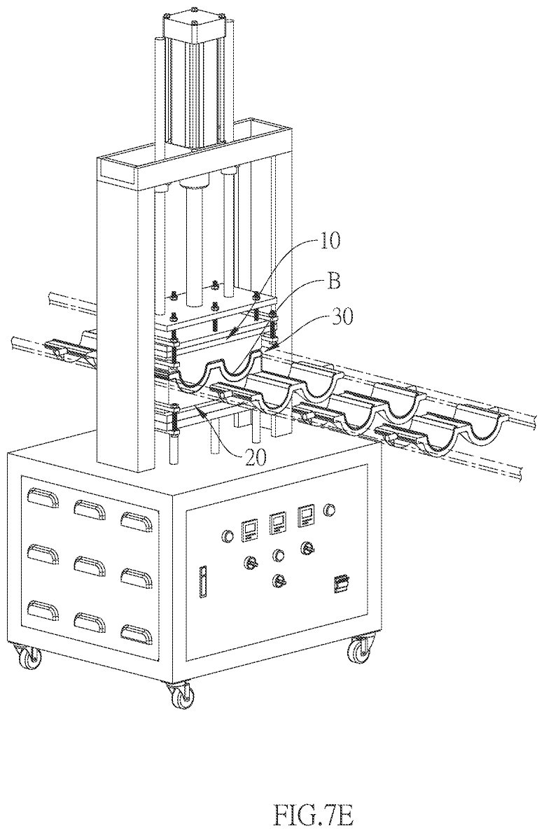

S02, dispose the raw material B: as shown in FIG. 3, FIG. 5, and FIG. 7A, the raw material B adapted to be molded is disposed on each of the middle dies 30; and one of the middle dies 30 having the raw material B is moved to the position between the top die 10 and the bottom die 20;

S03, process the raw material B with the molding tool 100; as shown in FIG. 7A and FIG. 7B, the top die 10 and the bottom die 20 are driven to move towards each other until the top die 10, the bottom die 20, and the middle die 30 are clamped to mold the raw material B:

S04, retract the top die 10 and the bottom die 20: as shown in FIG. 4 and FIG. 7C, after the raw material B in the molding tool 100 is molded into the required object, the top die 10 and the bottom die 20 are driven to move away from each other until the top die 10 and the bottom die 20 are separated by a predetermined distance H;

S05. Withdraw the middle die 30: as shown in FIG. 7D, the middle die 30 located between the top die 10 and the bottom die 20 is withdrawn; and

S06, move another one of the middle dies 30 to process the raw material B; as shown in FIG. 7D and FIG. 7E, the another middle die 30 having the raw material B is moved to the position between the top die 10 and the bottom die 20, and the top die 10 and the bottom die 20 are driven to move towards each other until the top die 10, the bottom die 20, and the another middle die 30 are clamped to mold the raw material B of the another middle die 30.

Referring to FIG. 7A, the molding apparatus 200 of the current embodiment is taken as an example to illustrate how the top die 10 and the bottom die 20 move towards or away from each other as mentioned in each step of the method of molding objects, wherein the driving cylinder 48 of the first driving device 40 drives the top die 10 to lift or decline to move relative to the bottom die 20 in which a position of the bottom die 20 is fixed, so that the top die 10 and the bottom die 20 could move towards or away from each other. However, in other embodiments, the bottom die 20 could be driven by a linear actuator to lift or decline, and a position of the top die 10 could be fixed, so that the top die 10 and the bottom die 20 could move towards or away from each other as well; alternatively, both the top die 10 and the bottom die 20 are driven by a linear actuator to move towards or away from each other at the same time.

The molding apparatus 200 of the current embodiment is taken as an example to illustrate how each of the middle dies 30 is moved as mentioned in each step of the method of molding objects, wherein the middle dies 30 are arranged in a row on the second driving device 50 having the conveyor 52, and the conveyor 52 moves one of the middle dies 30 having the raw material B to the position between the top die 10 and the bottom die 20 and withdraws the corresponding middle die 30 from the position between the top die 10 and the bottom die 20 after processing. Besides, the second driving device 50 of the present invention is not limited to the conveyor 52, but could be at least one robotic arm to move each of the middle dies 30 to the position between the top die 10 and the bottom die 20 or withdraw the corresponding middle die 30 located between the top die 10 and the bottom die 20.

It must be pointed out that the embodiments described above are only some preferred embodiments of the present invention. All equivalent structures and methods which employ the concepts disclosed in this specification and the appended claims should fall within the scope of the present invention.

What is claimed is:

1. A molding tool, comprising:
a top die;
a bottom die; and
at least two middle dies:
wherein each of the middle dies has a molding hole that is penetrating therethrough;
either the top die or the bottom die has a core adapted to mold objects, and the other of the top die and the bottom die has a partial cavity; the partial cavity and the molding hole of each of the middle dies jointly form a cavity matching with the core; the top die is opposite to the bottom die; one or both of the top die and the bottom die is/are driven to move towards or away from each other; the middle dies are respectively moved to a position between the top die and the bottom die, allowing one of the middle dies to be clamped with the top die and the bottom die.

2. The molding tool as claimed in claim 1, w % herein a bottom of the top die has the core, and a top of the bottom die has the partial cavity; each of the middle die has a frame structure on a periphery of the molding hole; when the top die and the bottom die clamp one of the middle dies, the frame structure is clamped between the core of the top die and a part of the bottom die located on a periphery of the partial cavity.

3. The molding tool as claimed in claim 2, wherein a top surface of the frame structure has at least one positioning pin.

4. The molding tool as claimed in claim 1, wherein a left side and a right side of each of the middle dies respectively have a lug protruding out of a boundary in which each of the middle dies is clamped with the top die and the bottom die.

5. The molding tool as claimed in claim 2, wherein a left side and a right side of each of the middle dies respectively have a lug protruding out of a boundary in which each of the middle dies is clamped with the top die and the bottom die.

6. The molding tool as claimed in claim 3, wherein a left side and a right side of each of the middle dies respectively have a lug protruding out of a boundary in which each of the middle dies is clamped with the top die and the bottom die.

7. A molding apparatus, comprising:
a first driving device;
a second driving device; and
the molding tool as claimed in claim 1;
wherein the top die and the bottom die are disposed on the first driving device to face each other; the first driving device drives one or both of the top die and the bottom die to move towards or away from each other along a straight-line direction; the middle dies are arranged in a row on the second driving device, and are respectively moved to or retracted from the position between the top die and the bottom die along a direction perpendicular to the straight-line direction.

8. A molding apparatus, comprising:
a first driving device;
a second driving device; and
the molding tool as claimed in claim 2;
wherein the top die and the bottom die are disposed on the first driving device to face each other; the first driving device drives one or both of the top die and the bottom die to move towards or away from each other along a straight-line direction; the middle dies are arranged in a row on the second driving device, and are respectively moved to or retracted from the position between the top die and the bottom die along a direction perpendicular to the straight-line direction.

9. A molding apparatus, comprising:
a first driving device;
a second driving device; and
the molding tool as claimed in claim 3;
wherein the top die and the bottom die are disposed on the first driving device and face each other; the first driving device drives one or both of the top die and the bottom die to move towards or away from each other along a straight-line direction; the middle dies are arranged in a row on the second driving device, and are respectively moved to or retracted from the position between the top die and the bottom die along a direction perpendicular to the straight-line direction.

10. The molding apparatus as claimed in claim 7, wherein the first driving device comprises a bottom base; a bottom seat is disposed on the bottom base, and the bottom die is disposed on the bottom seat; a frame is disposed on the bottom base and has a crossbeam located on the top of the bottom seat; a driving cylinder is engaged with a middle of the crossbeam and has a piston rod extending bottomwards; a bottom end of the driving cylinder is engaged with a top seat, wherein the top die is disposed on the top seat.

11. The molding apparatus as claimed in claim 8, wherein the first driving device comprises a bottom base; a bottom seat is disposed on the bottom base, and the bottom die is disposed on the bottom seat; a frame is disposed on the bottom base and has a crossbeam located on the top of the bottom seat; a driving cylinder is engaged with a middle of the crossbeam and has a piston rod extending bottomwards; a bottom end of the driving cylinder is engaged with a top seat, wherein the top die is disposed on the top seat.

12. The molding apparatus as claimed in claim 9, wherein the first driving device comprises a bottom base; a bottom seat is disposed on the bottom base, and the bottom die is disposed on the bottom seat; a frame is disposed on the bottom base and has a crossbeam located on the top of the bottom seat; a driving cylinder is engaged with a middle of the crossbeam and has a piston rod extending bottomwards; a bottom end of the driving cylinder is engaged with a top seat, wherein the top die is disposed on the top seat.

13. The molding apparatus as claimed in claim 7, wherein a left side and a right side of each of the middle dies respectively have a lug, and the second driving device has a conveyor including two belts arranged by an internal in a left-right direction; the two belts respectively pass through a left side and a right side of a position in which the top die and the bottom die clamp the middle dies, and each of the middle dies is engaged with the two belts via the two lugs.

14. The molding apparatus as claimed in claim 8, wherein a left side and a right side of each of the middle dies respectively have a lug, and the second driving device has a conveyor including two belts arranged by an internal in a left-right direction; the two belts respectively pass through a left side and a right side of a position in which the top die and the bottom die clamp the middle dies, and each of the middle dies is engaged with the two belts via the two lugs.

15. The molding apparatus as claimed in claim 9, wherein a left side and a right side of each of the middle dies respectively have a lug, and the second driving device has a conveyor including two belts arranged by an internal in a left-right direction; the two belts respectively pass through a left side and a right side of a position in which the top die and the bottom die clamp the middle dies, and each of the middle dies is engaged with the two belts via the two lugs.

16. The molding apparatus as claimed in claim 10, wherein a left side and a right side of each of the middle dies respectively have a lug, and the second driving device has a conveyor including two belts arranged by an internal in a left-right direction; the two belts respectively pass through a left side and a right side of a position in which the top die and the bottom die clamp the middle dies, and each of the middle dies is engaged with the two belts via the two lugs.

17. The molding apparatus as claimed in claim 11, wherein a left side and a right side of each of the middle dies respectively have a lug, and the second driving device has a conveyor including two belts arranged by an internal in a left-right direction; the two belts respectively pass through a left side and a right side of a position in which the top die and the bottom die clamp the middle dies, and each of the middle dies is engaged with the two belts via the two lugs.

18. The molding apparatus as claimed in claim 12, wherein a left side and a right side of each of the middle dies respectively have a lug, and the second driving device has a conveyor including two belts arranged by an internal in a left-right direction; the two belts respectively pass through a left side and a right side of a position in which the top die and the bottom die clamp the middle dies, and each of the middle dies is engaged with the two belts via the two lugs.

19. A method of molding objects, comprising steps of:
preparing the molding tool as claimed in claim 1;
disposing a raw material adapted to be molded on each of the middle dies, and moving one of the middle dies to the position between the top die and the bottom die;
driving one or both of the top die and the bottom die to move towards each other until the top die, the bottom die, and the middle die are clamped to mold the raw material,
driving one or both of the top die and the bottom die to move away from each other until the top die and the bottom die are separated by a predetermined distance after the raw material in the molding tool is molded into a required object;
withdrawing one of the middle dies located between the top die and the bottom die; and
moving another one of the middle dies having the raw material to the position between the top die and the bottom die, and driving one or both of the top die and the bottom die to move towards each other until the top die, the bottom die, and the another middle die are clamped to mold the raw material of the another middle die.

20. A method of molding objects, comprising steps of:
preparing the molding tool as claimed in claim 2;
disposing a raw material adapted to be molded on each of the middle dies, and moving one of the middle dies to the position between the top die and the bottom die;
driving one or both of the top die and the bottom die to move towards each other until the top die, the bottom die, and the middle die are clamped to mold the raw material;
driving one or both of the top die and the bottom die to move away from each other until the top die and the bottom die are separated by a predetermined distance after the raw material in the molding tool is molded into a required object;
withdrawing one of the middle dies located between the top die and the bottom die; and
moving another one of the middle dies having the raw material to the position between the top die and the bottom die, and driving one or both of the top die and the bottom die to move towards each other until the top die, the bottom die, and the another middle die are clamped to mold the raw material of the another middle die.

21. The method as claimed in claim 19, wherein each of the middle dies has a frame structure on a periphery of the molding hole; a top surface of the frame structure has at least one positioning pin; the raw material on each of the middle dies is penetrated by the at least one positioning pin for positioning.

22. The method as claimed in claim 20, wherein a top surface of the frame structure has at least one positioning pin; the raw material on each of the middle dies is penetrated by the at least one positioning pin for positioning.

23. The method as claimed in claim 19, wherein the molding tool comprises a conveyor, and the middle dies are arranged in a row on the conveyor; each of the middle dies is moved to the position between the top die and the bottom die through the conveyor and one of the middle dies located between the top die and the bottom die is withdrawn through the conveyor.

24. The method as claimed in claim 20, wherein the molding tool comprises a conveyor, and the middle dies are arranged in a row on the conveyor; each of the middle dies is moved to the position between the top die and the bottom die through the conveyor and one of the middle dies located between the top die and the bottom die is withdrawn through the conveyor.

25. The method as claimed in claim 21, wherein the molding tool comprises a conveyor, and the middle dies are arranged in a row on the conveyor; each of the middle dies is moved to the position between the top die and the bottom die through the conveyor and one of the middle dies located between the top die and the bottom die is withdrawn through the conveyor.

26. The method as claimed in claim 22, wherein the molding tool comprises a conveyor, and the middle dies are arranged in a row on the conveyor; each of the middle dies is moved to the position between the top die and the bottom die through the conveyor and one of the middle dies located between the top die and the bottom die is withdrawn through the conveyor.
